(19) United States
(12) Patent Application Publication
(10) Pub. No.: US 2015/0302179 A1
(43) Pub. Date: Oct. 22, 2015

(54) Real-time aggregation and display of data

(71) Applicant: Mark Rheault, Moorhead, MN (US)

(72) Inventor: Mark Rheault, Moorhead, MN (US)

(21) Appl. No.: 14/686,699

(22) Filed: Apr. 14, 2015

Related U.S. Application Data
(60) Provisional application No. 61/979,396, filed on Apr. 14, 2014.

(51) Int. Cl. G06F 19/00

(52) U.S. Cl. CPC G06F 19/363

(57) ABSTRACT

Real-time technologies and data and gamification techniques, such as badges, leaderboards, performance scores, and other elements, to generate improvement in the work performance of employees, teams/departments, facilities, and organizations by providing actionable information via real-time dashboards using a variety of user interfaces. The invention also supports the automation of patient and staff workflow activities to enable optimized processes.

### CROSS-REFERENCE TO RELATED APPLICATIONS

The present application claims the benefit of co-pending U.S. provisional application No. 61/979,396, filed on Apr. 14, 2014, the entire disclosure of which is incorporated by reference as if set forth in its entirety herein.

### FIELD

The invention generally relates to the collection, processing, and displaying of information gathered in real-time from a variety of sensors, devices, software applications, and other sources. More particularly, the invention concerns measurements related to individual performance displayed on a variety of user interfaces to drive improved performance using a variety of “gamification” techniques.

### BACKGROUND

Electronic dashboard tools and interfaces are commonly used today that display raw or calculated data that is often not in “real-time”—data that represents current (within seconds or a few minutes) information about the status and/or condition of a person, thing, or activity. Much of this data is that represents information over a period of time in order to indicate periodic (hour, day, week, month) measurements or trends.

More recently, some systems have begun displaying real-time information based on either manually inputted or automatically collected information from sensors or other technology systems. However, this information is commonly displayed on standard interfaces that do not allow for interactivity, but merely display pre-programmed or configured information not intended for interaction with the person(s) viewing it.

Some displays do allow for touch-screen interactivity, such as information kiosks used to search for a particular piece of information. These rely on user “requests” to determine which information to display rather than using algorithms to “push” the anticipated information to the user without their needing to request it.

The information displayed in these interfaces is typically intended to provide insight into trends and periodic measurements that would lead them to make to make more general changes to impact future performance.

The display of the information is often constrained to use and viewing by managers and company executives rather than individual “front-line” staff performing many of the operational activities.

The displayed information does not typically dynamically change based on the display device (mobile phone, wall-mounted television, kiosk, etc.) automatically identifying where it is physically located inside of an enclosed structure or confined campus (small distances separating multiple buildings that are part of a single organization).

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

One embodiment of the invention includes the collection, processing/calculating, and display of information “pushed” to the various interfaces used by users of the system that is personalized to their individual, team, site, or enterprise's performance.

Another embodiment of the invention uses a variety of “gamification” techniques to drive the user's motivation to improve their work-related performance specifically related to their role. The information is intended to drive improved performance during the current period, that being the current, hour, day, week, month, and or year, with an emphasis on the current day or week.

Embodiments of the invention use data automatically collected from a variety of sources and processed in real-time for display in a variety of display interfaces and/or external Application Programming Interfaces (APIs) (refer to Drawing 1).

With the exception of the web browser based interface in which the user can “drill down” into more detailed information and provide more interactive functionality, the interfaces are intended to simplify frequent user engagement and “at a glance” views of current performance metrics many times throughout a day by (1) providing many different mobile interfaces, and (2) enabling minimal or auto-logging in of the user to be able to quickly view the performance data and change between pre-configured views set up via the system's web browser configuration application.

In one aspect, embodiments of the present invention relate to a system for analyzing patient experiences. The system includes at least one interface and a processing module. The at least one interface is configured to receive data from a data source relating to a patient visit to a healthcare facility. The processing module is configured to analyze the received data and associate it with a patient visit identification identifier unique to each patient.

In one embodiment, the system further comprises a user interface and the processing module is further configured to present the analyzed data using the user interface. In one embodiment, the data source is selected from the group consisting of a healthcare information system, a medical device, and a real-time location system. In one embodiment, the system further includes a data store and the processing module is further configured to store the associated data in the data store.

In one embodiment, the system further comprises a user interface and the processing module is further configured to receive a condition via the user interface. The processing module may be further configured to issue a real-time notification via the user interface when the analysis indicates that the received data satisfies the received condition.

In one embodiment, the system includes a plurality of interfaces and the processing module is further configured to identify commonalities in data received from a plurality of sources. In one embodiment, the processing module is further configured to compare data associated with different patients.

In another aspect, embodiments of the present invention relate to a computer implemented method for analyzing patient experiences. The method includes receiving, using at least one interface, data from a data source relating to a patient visit to a healthcare facility; analyzing, using a configured processing module, the received data; and associating, using the configured processing module, the received data with a patient visit identification identifier unique to each patient.

In one embodiment, the method further comprises presenting the analyzed user data using a user interface. In one embodiment, receiving data from a data source comprises receiving data from a data source selected from the group consisting of a healthcare information system, a medical device, and a real-time location system. In one embodiment, the method further includes storing the associated data in a data store. In one embodiment, the method further includes receiving a condition via a user interface. The method may further include issuing a real-time notification via the user interface where the analysis indicates that the received data satisfies the received condition.

In one embodiment, the method further includes identifying, using the configured processing module, commonalities in data received from a plurality of sources using a plurality of interfaces. In one embodiment, the method further includes comparing, using the configured processing module, data associated with different patients.

In yet another aspect, embodiments of the present invention relate to a computer readable medium containing computer-executable instructions for performing a method for analyzing patient experiences. The medium includes computer-executable instructions for: receiving, using at least one interface, data from a data source relating to a patient visit to a healthcare facility; analyzing, using a configured processing module, the received data; and associating, using the configured processing module, the received data with a patient visit identification identifier unique to each patient.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following figures in which:

FIG. 1—Overview Illustration of the Infinite Leap Real-Time Performance Suite

FIG. 2—Real-Time Dashboards Using Gamification Techniques

FIG. 3—Mission Control Resource Allocation Management

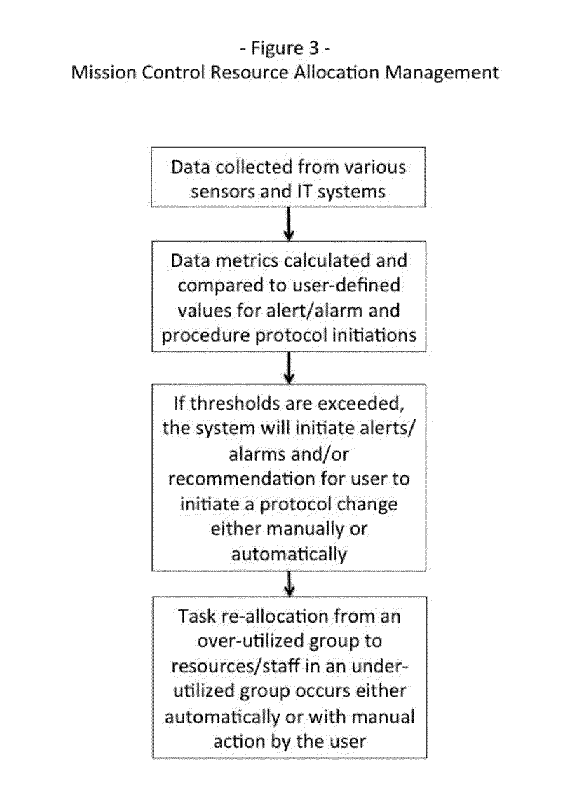

FIG. 4—Real-Time Feedback Processing & Response

FIG. 5—Smart-Watch Interface for Real-Time Performance System

FIG. 6—Use Of Auto-Identification via RTLS/BLE/RFID to Auto-Login/Logout to a Workstation and Auto-Navigate to a Patient Chart

FIG. 7—Use Of Auto-Identification via RTLS/BLE/RFID to Auto-Login to a Display Device and Be Presented with a Personalized Dashboard

FIG. 8—Use of a “Smart TV” to Display Automated Logistical Information at a Particular Location

FIG. 9—Use of RTLS for Automated Routing Inside a Building with Predicted Destination Based on Information from Third Party System

FIG. 10—Automated Queue Management Using RTLS

FIG. 11—Use of Touch-Free Methods of Using and Navigating Real-Time Dashboards on a Display Device

FIG. 12—Calculation of a “Performance Score” Based on Collection and Processing of Real-Time Performance Data

FIG. 13—Automated Prompt for Managerial Feedback for Routing to Individuals or Groups

FIG. 14—Real-Time Activity Based Costing Using Automatically Collected Data

FIG. 15—Overview illustration of the Real-Time Performance Management System architecture.

FIG. 16—Patient Experience Context Engine.

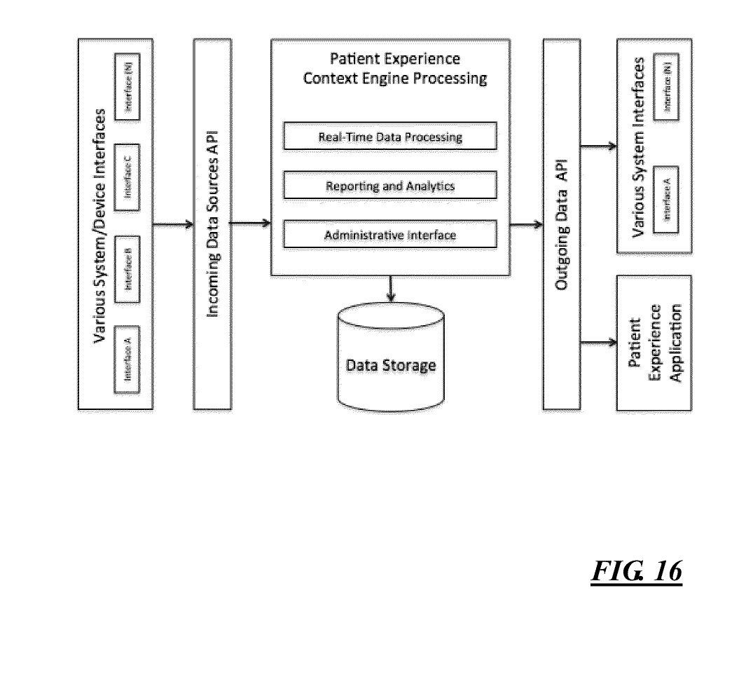

In the drawings, like reference characters generally refer to corresponding parts throughout the different views. The drawings are not necessarily to scale, emphasis instead being placed on the principles and concepts of operation.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. The following detailed description is, therefore, not to be taken in a limiting sense.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

### Real-Time Dashboards Using Gamification Techniques

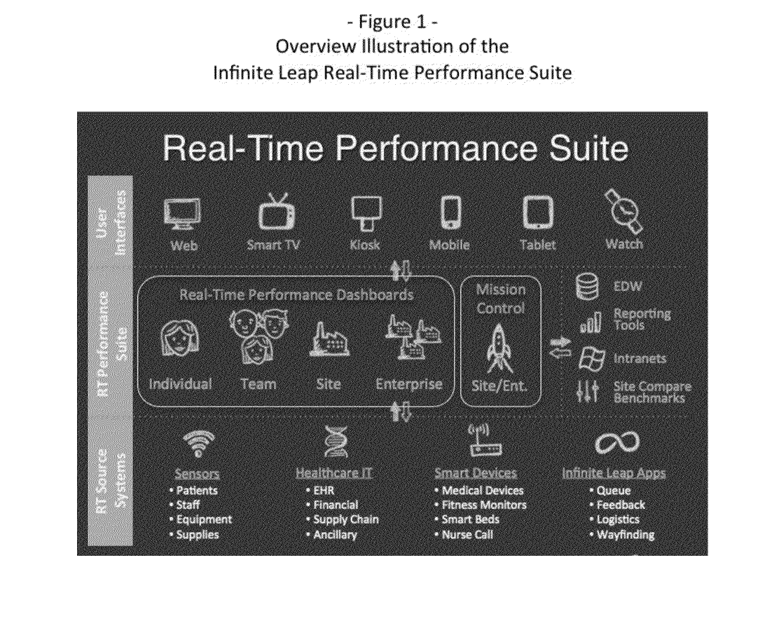

The Real-Time Performance Dashboards and related system components (“System”), used collectively here, are depicted in FIG. 1. The dashboard applications include a data collection and processing subsystem that first collects the data from many sources in real-time, processes it, and stores it for use in the dashboards and other System components.

The dashboards include data sets, metrics, and views for various levels of a typical organizational hierarchy—Individual, Team, Site, and Enterprise. These views are generated for use by the different front-line staff, mid-level managers, facility level executives, and corporate executives, respectively. These metrics are intended for the various staff members to view to understand their personal performance, the team or department's performance, as well as how the facility or organization is operating all in real-time. This enables the staff at all levels to understand their personal, team, and/or organizational performance and make immediate changes to improve the performance without delaying or relying on periodic status or trend reports, as is the predominant norm for organizations today.

The System couples this real-time performance data together with “gamification” techniques that have been proven effective in driving significantly greater employee motivation through the continuous updates on their performance relative to goals or benchmarks for them individually and also as compared to their team or peers. With this information readily available, the employees begin to drive towards achieving their goals, beating their previous best performance, and helping their team achieve its goals as well.

To further tap into this innate human emotion, gamification techniques are used in driving improved work performance by presenting users with their performance using auto-collected real-time data, which is the only feasible way to provide continuous accurate performance metrics relevant to their unique role.

The System will utilize several gamification techniques, including the awarding of virtual “badges” or “tokens” which may be accumulated over time. The organization may choose to put a value to these, if they so choose, such as trading them in for a free lunch, a gift card, or money. Other techniques include electronic or printed leaderboards, peer comparisons/rankings, “Hall of Fame” performers, goal achievement statistics, recognition boards, record books, most improved performers, longest streaks, and other similar performance measurement and recognition.

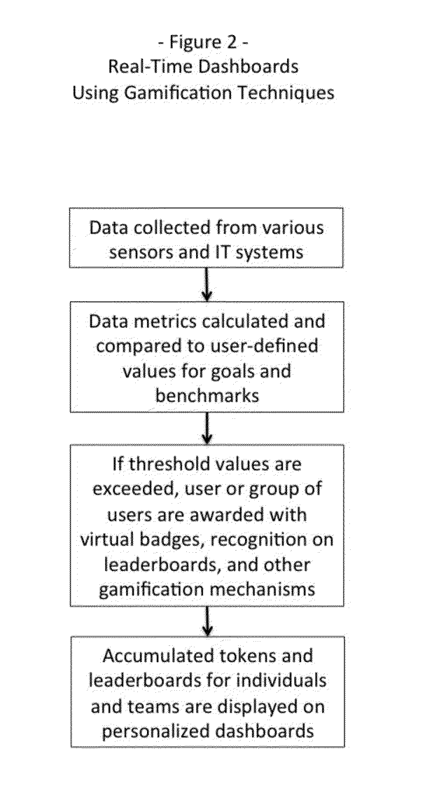

The System will focus on pushing the real-time performance results in these various ways out to the employees on a variety of user interfaces, as represented in both FIG. 1 and the process illustration in FIG. 2, so that the real-time data and status is readily available for employees to view frequently throughout the day. This is a needed for a successful gamification strategy.

### Automated Resource Allocation Management System (“Mission Control”)

Using the System described as a base, the Automated Resource Allocation Management System (“Mission Control”), uses the dashboards and other System components to offer extended functionality related to optimizing resource allocation (staff, equipment, supplies), coordinating and sharing tasks among various departments, invoking changes in process protocols, and other facility or organizational level coordination activities.

By having full visibility into the real-time status of all the major operational activities in the organization through the System, the Mission Control application will be able to support processes, workflows and activity management across the organization to create even greater efficiencies than are possible without the use of the underlying technologies, subsystems, dashboards, and the Mission Control application. These newly enabled features include task balancing among staff, procedure initiation, dispatch, alert/alarm/issue response and resolution documentation, auto-dispatch/assignment to staff in other departments/teams, equipment sharing among departments or facilities, automated recommendations to Mission Control users when certain process protocols should be invoked, and more.

### Real-Time Feedback Processing & Response

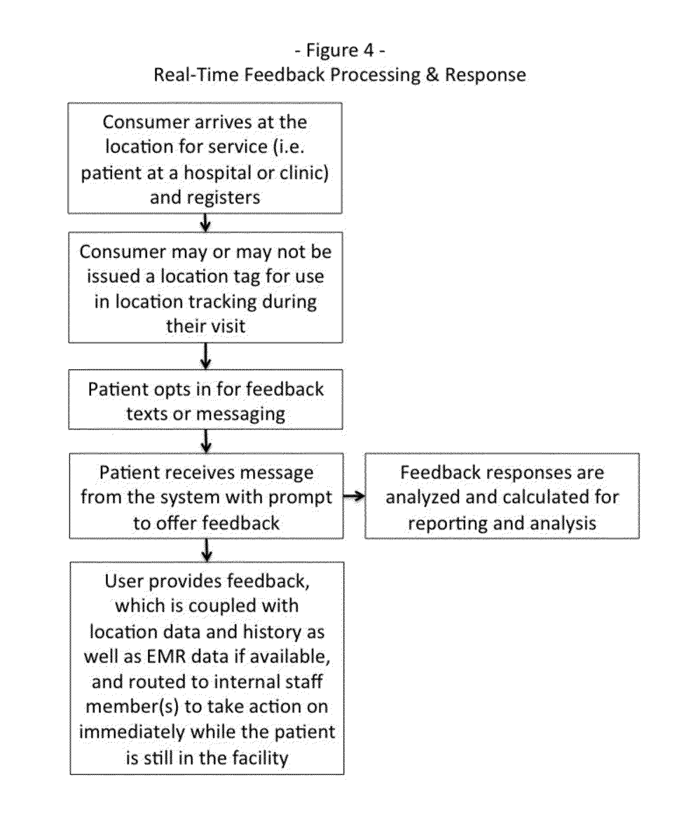

The overall System relies on source feeds of real-time information, such as those represented in FIG. 1. One of those feeder systems is a Real-Time Processing and Response system. The process for this system is illustrated in FIG. 4.

The process the software enables is based on the use of RTLS and mobile phone technologies, with enhanced functionality if an electronic medical record is integrated into the process as well. As FIG. 4 illustrates, a consumer (e.g., a patient at a clinic visit) arrives and receives an RTLS badge from a staff member which is then used to monitor their location for the duration of their visit. Upon registration of their arrival, the patient is requested to participate in the organization's feedback program. If they agree, the Real-Time Feedback system automatically sends a message to their phone via a text message or the organization's downloadable mobile app the patient may have installed. If at some point during their visit the consumer wishes to provide feedback, they may submit their feedback by (1) clicking on the link provided which brings them to a web form, (2) they may simply reply to the text message sent to them, or (3) they provide it via the mobile app, if they downloaded it.

Upon receiving the feedback in any of the described methods, the Real-Time Feedback System immediately (1) provides it to the administration console that is monitored by a person or team designated by the organization (2) sends notifications and/or alerts to all designated employees or response personal based on where the patient was being served. The system appends to the feedback data automatically collected about the patient and the particular visit to provide as much context as possible to the designated responders, to whom the goal is to address any issues the patient has while they are still in the facility. The additional information automatically collected and provided to the responding individuals may include such information as: (1) appointment or condition information from the electronic medical record, (2) patient's location when the feedback was submitted, (3) patient's current location, (4) patient visit metrics such as time waited, stage of visit, total length of stay, etc., (5) department names and individual names the patient encountered along with a full chronology of their visit, (6) prior feedback they may have submitted, and (7) the name and contact information for the current shift leader in the department the patient is currently located so that they may be contacted, if desired.

Upon addressing the patient feedback or issue, the response description is then entered by the response individuals/team and the data is made available in various reports available to designated individuals in the organization by the system's administrators.

### Smart-Watch Interface for Real-Time Performance System

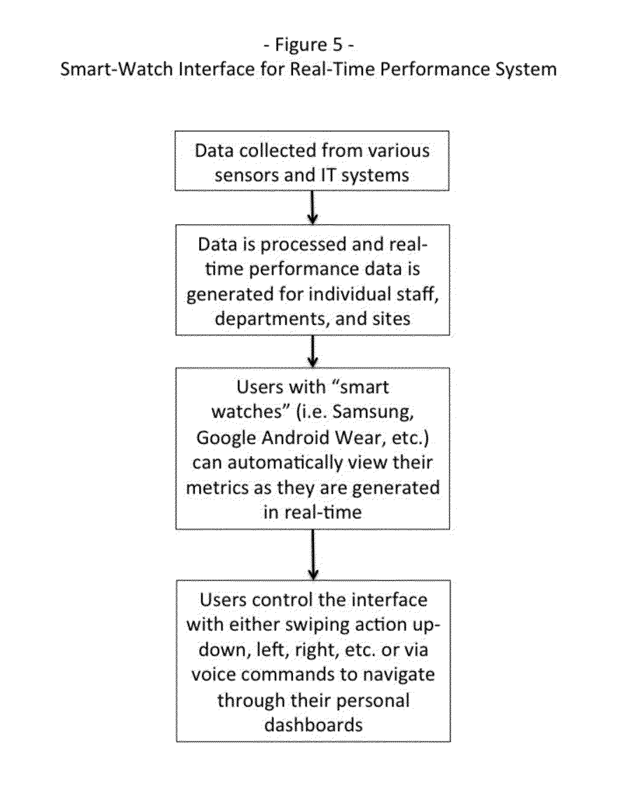

As a part of the overall system (see FIG. 1), “Smart Watches” will be utilized to present the dashboard information in real-time on the watch interface. The different metrics may be configured ahead of time via the web-based administrative interface for the smart watch application. The data will be optimized for the interface by allowing the wearer to review their personalized metrics via (1) touch, (2) swiping action, or (3) voice control. The process for the collection and display of the real time data via the smart watch interface is described in FIG. 5.

One unique aspect is the way the real-time metrics are displayed. The user will be able to navigate up and down to view one set of metrics, such as five of their personal metrics for the current day, and then navigate left or right to navigate to the next set of metrics, such as their 5 individual metrics for the current week, their team's combined metrics for the day/week, and other key metrics they so choose. The metrics will also display key indicators using colors and icons to indicate how the metrics compare to defined goals, how an individual is comparing to their peers or previous benchmarks, or if they have received tokens for achievements of the goal for the time period based on the gamification features of the system.

The smart watch will also be an interface for other related features of the overall system, such as receiving and acknowledging task acceptance and completion, receiving alerts/alarms generated or passed by the system, and other relevant features. The aforementioned features and navigation process will allow for this to work in concert with the frequent viewing of their smart watch dashboard.

### Use of Auto-Identification Via RTLS/BLE/RFID to Auto-Login/Logout to a Workstation and Auto-Navigate to a Patient Chart

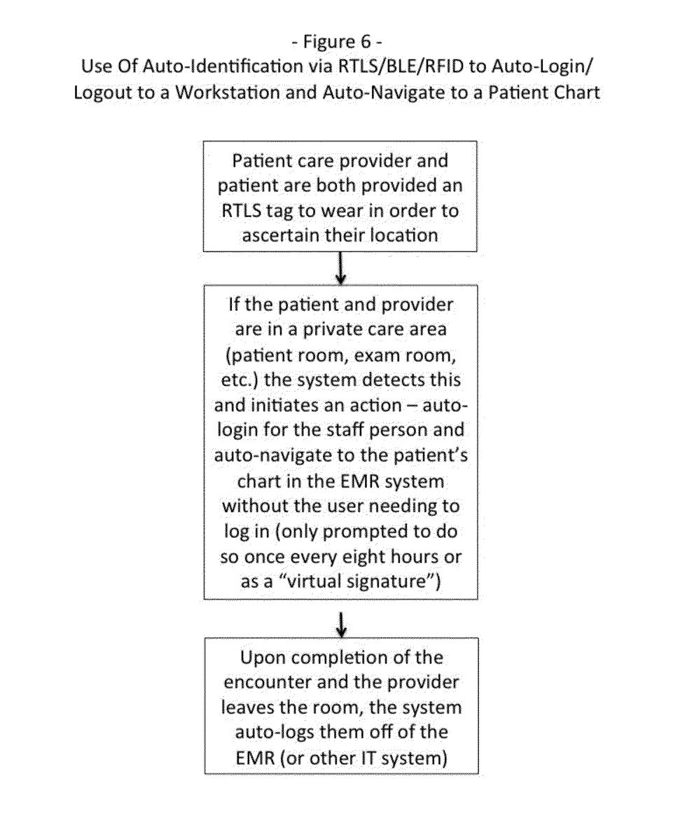

As part of the overall System and the interfaces and logic used in the system, the system will support the ability to use real-time location information from the RTLS/Bluetooth Low Energy (BLE)/RFID sensory devices to authenticate a user for the purpose of signing into a third party software application, such as a medical record. The process for this is illustrated in FIG. 6.

Upon a staff member wearing an auto-identification device entering a room (i.e. patient room, exam room) to provide treatment to a patient therein, the System will recognize they are in that location, determine if there is a registered workstation in the same room, and based on rules and configuration settings established by the system administrator, the System will send the appropriate information to the third-party software application so that it will automatically log the staff person on to the workstation and software application. Further, if a patient is in the room and is also wearing an auto-identification device, the System will send another message to the third-party software application to automatically navigate to the patient's chart or other designated screen as configured in the System's administrative screens. Further, should the staff member leave the room without manually logging off of the workstation, the System will send a message to the third-party software application to automatically log the staff member off the system to ensure that unauthorized access to the workstation by the patient or another individual is not possible.

Use of Auto-Identification Via RTLS/BLE/RFID to Auto-Login to a Display Device and be Presented with a Personalized Dashboard

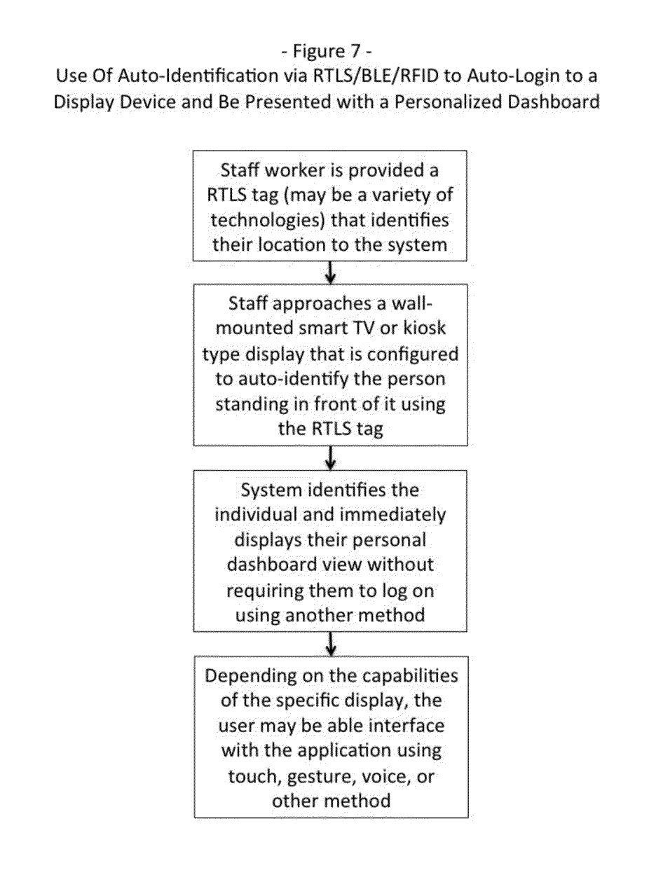

Similar to the above scenario, the System will also enable the auto-login and log-off of a display device that is likely fixed in its location, such as a wall-mounted LCD screen or a kiosk, based on an individual wearing an auto-identification device standing in front of the display device and their close proximity is sensed. The process for this is illustrated in FIG. 7.

Upon positioning directly in front of the display device, the system will detect the auto-identification device via a sensor also mounted near the display and validate the individual is remaining in front of the display device and not simply walking past it. Once validated the System will immediately change the display over to the individual's personal dashboard view for them to review and also interact with. After they have finished their session, they simply walk away and they are auto-logged off of the system and the display returns to its previous state.

### Use of a “Smart TV” to Display Automated Logistical Information at a Particular Location

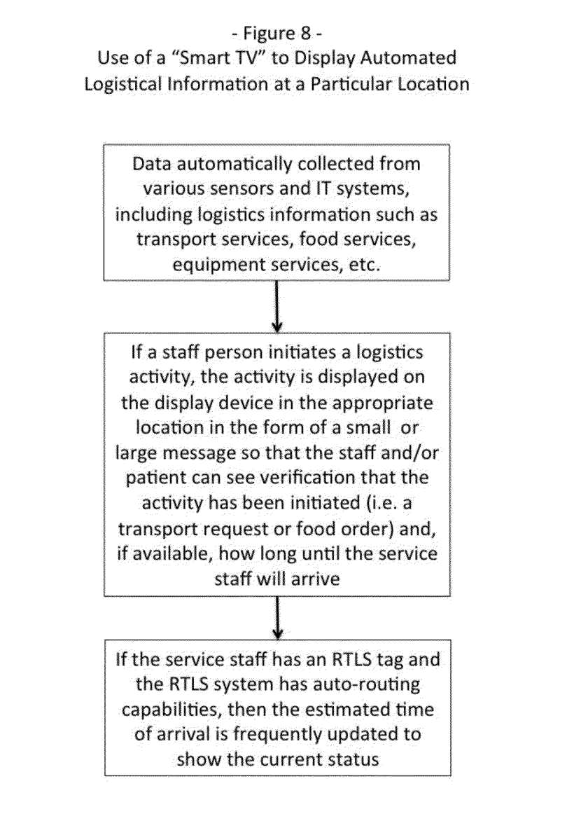

With a “smart TV” (one that one can control screen contents on like a computer screen) in patient rooms, break rooms, procedure areas, and so forth—the System will be able to push context aware and specific information to any particular Smart TV in the organization that is connected to the System. Refer to FIG. 8 for a description of the workflow regarding this.

For example, a nurse in a room with a patient would like to call for the Transport Department to bring a wheelchair up to the patient's room and transport them to a particular location. In this case, the nurse could, while in the patient's room, press a button on his or her RTLS device that has been configured to initiate a transport request. Because she is in the patient's room (e.g., Room 315), the System recognizes that and initiates a request to Transport to pick up the patient in room 315. It would then be manually or automatically assigned to a Transport staff person to complete. Once assigned, the System would calculate the estimated time to travel from their current location to Room 315 using the System's auto-routing capabilities. Finally, the System would then push out the information to the Smart TV mounted in room 315 to indicate that the transportation request was received and assigned out, and that the transport staff person should arrive in {X} minutes and {X} seconds. Further, the System would continue to push out the updates continuously to the Smart TV until the individual arrived such that an estimated time of arrival would essentially show a count down until they arrived, which would greatly help both the care provider and the patient in knowing this important piece of information.

This same use of the automated logistics features of the System would be used for many other tasks and requests, such as meal delivery, blood draws for lab, and other room or patient specific information that would aid the staff or the patient in being informed on the status of various activities concerning their care.

Use of RTLS for Automated Routing Inside a Building with Predicted Destination Based on Information from Third Party System

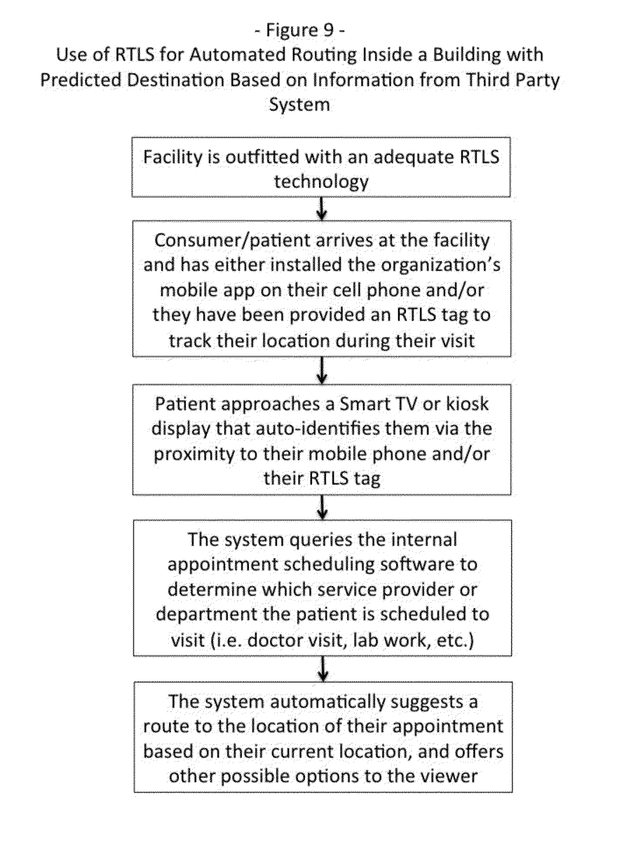

As part of an automated routing or “way finding” feature set included and/or used by the System, the System can enhance the functionality of the way finding service to the patient by adding intelligent context to their use of the system. Refer to process illustration in FIG. 9.

When the patient arrives, they will be provided an auto-identification tag or device, and/or they may have downloaded the way finding application that is integrated with the System on their personal mobile phone. Upon approaching a way finding enabled Smart TV or kiosk, the system will auto-identify them based on the auto-identification device provided to them or via their mobile phone. Once identified, the System will look up their appointment information and the location of the visit, and automatically provide the suggested route with turn-by-turn directions to get to their appointment location. Assuming multiple kiosks will be positioned throughout the facility, the patient may repeat this process as often as they wish as they navigate their way to their appointment, at each point the System will provide the relevant turn by turn instructions based on their current location. This functionality may be available on patient room Smart TVs so that they or visitors may choose locations as well, such as a cafeteria, parking garage, or a medical department. Conversely, a visitor could interact with a kiosk to search for a patient name and be provided the best route to navigate to their room or a particular department, along with the added intelligence of whether they are in the room currently, or have requested no visitors as their current status.

### Automated Queue Management Using RTLS

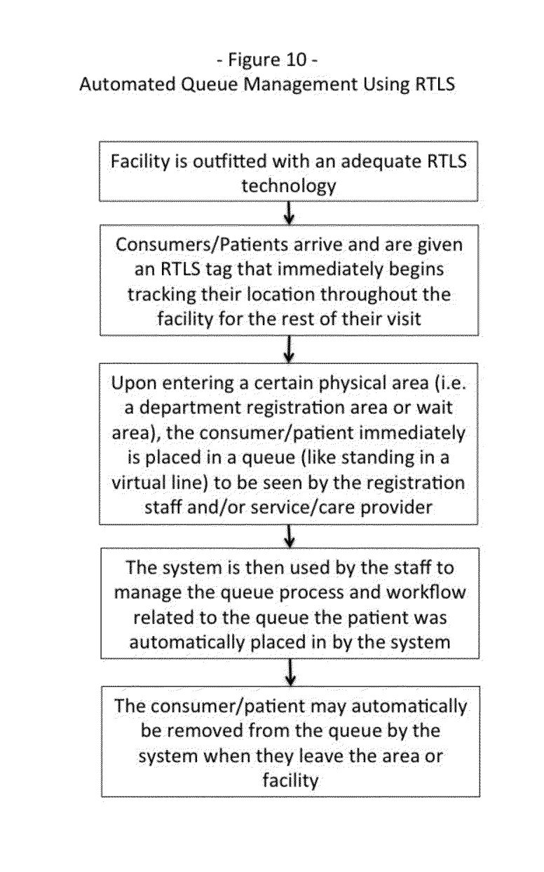

As a separate but integrated application of the System, the System will include Automated Queue Management for the purpose of managing registration and wait area queues for patients. Refer to FIG. 10 for additional detail on the process.

Patient queues, or lines, are used when patients arrive to a clinical facility for non-emergent care needs. The System provides enhanced innovative features to manage these queues in a more expeditious manner than what is available in comparable solutions today. The queuing process helps manage and minimize patient wait times by monitoring and managing the patient flow process from the time they enter the facility until they are registered, from the registration process until they are called from the wait area by a care provider, the wait times for subsequent phases of their appointment in other departments (e.g., visits to the lab for lab work or radiology for imaging to be completed), as well as managing the wait times while in an exam/patient room in which the patient is alone waiting for a provider to visit them.

With the Automated Queue System, the System tracks them through each of these phases automatically using the RTLS device the patient was provided when they arrived. When the patient enters defined zones associated with a wait and/or registration area, the System automatically detects the patient in the zone and immediately puts them into that area's queue. It manages all aspects of the workflow while they are in the queue, from providing them feedback on estimated wait times, when to go to the registration desk when the registration staff sends a “page” to their RTLS tag, and so forth. Also, if they leave the area or the registration process is completed, the queue manages their status related to that as well all automatically. Further, the system manages the interaction with the electronic medical record system as well as the tag cleaning and recycling process to ensure the tags are adequately sanitized before being placed back into service by the staff

### Use of Touch-Free Methods of Using and Navigating Real-Time Dashboards on a Display Device

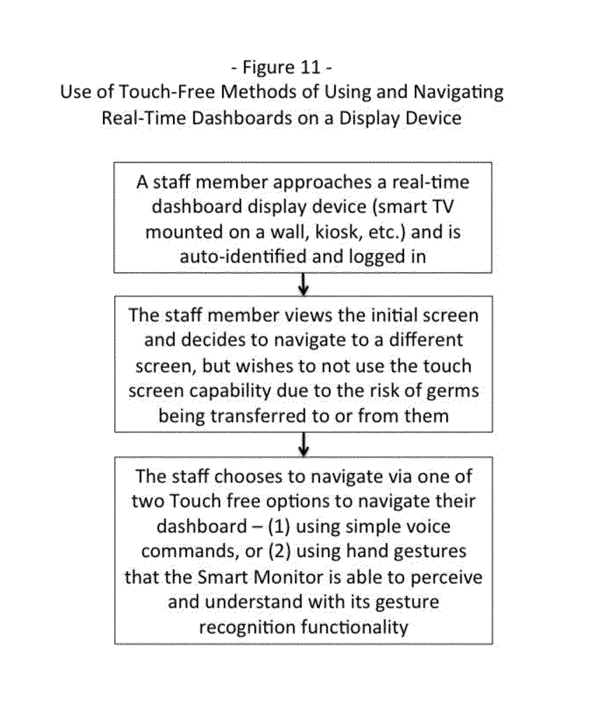

As part of the ease of use of the overall System as well as to minimize the spread of germs leading to hospital acquired infections, it is desirable to automate as much of the interaction of the user with the System as possible and also make changing views as simple and easy as possible. To this end, the System will include features that allow navigation among the various dashboard views at Smart TV and kiosk stations without needing to actually touch the screen. Refer to FIG. 11 for additional information about the process the staff will use for gesture control and voice control of the display devices.

Once the staff has been auto-logged into the display device and is viewing their personal dashboard or departmental dashboard at, for example, a wall-mounted Smart TV, they may use either gesture control or voice control to navigate to other dashboard views or interact with the display in other ways supported.

### Calculation of a “Performance Score” Based on Collection and Processing of Real-Time Performance Data

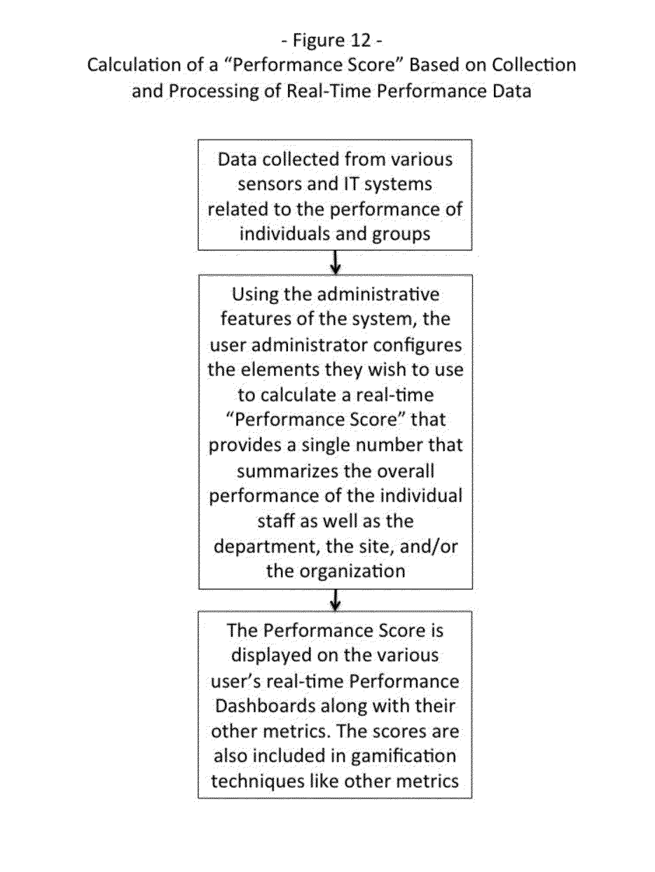

In an effort to provide a very simple and easy to understand “scoring” of the employee, team/department, facility, and/or organization performance, the System shall generate a numerical score representative of the performance of the measure individual or group. Refer to FIG. 12 for details of this process.

As all of the real-time data is collected and stored, the Performance Scores will be calculated in real-time based on algorithms used by the System that are influenced by the configuration options selected by the administrative users of the System through the web browser based administrative interface. The Performance Scores are then represented and used in the various real-time dashboards, trend and historical reports, and as part of the gamification features (badges, tokens, leaderboards, etc.) used by the System.

### Automated Prompt for Managerial Feedback for Routing to Individuals or Groups

The System continuously monitors individual, team/department, facility, and organization performance across a multitude of measures and is also continuously comparing the values of the performance against established goals, benchmarks, and thresholds. The System also allows for notifications and alerts to be triggered by exceeding certain thresholds, such as to managers and executives.

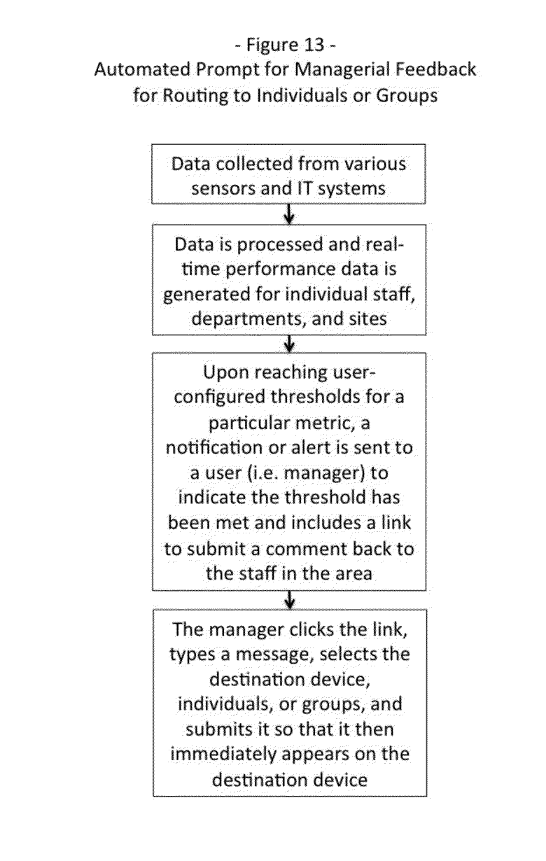

In an effort to facilitate responsive, time-sensitive communication between the managers and either an individual or group, the System shall provide a mechanism to quickly and efficiently communicate to an individual or a group through the System's dashboards and notification systems. Refer to FIG. 13 for additional information related to this process.

When the manager or executive is notified of a threshold being exceeded (either a in a positive or negative way), a link is included in the notification message that the manager may receive on their mobile device, in an email message, or in a text message. Upon clicking the link, the manager or executive may enter a brief communication (i.e. “Great job achieving 94% on your on-time starts team! Keep it up!—Jane Doe, COO”) and then designate where it should be sent to (1) a departmental dashboard display, (2) to an individual, or (3) to a group. It is then transmitted and shown on the appropriate dashboard or received as an email or other type of message if destined for specific individuals or groups.

### Real-Time Activity Based Costing Using Automatically Collected Data

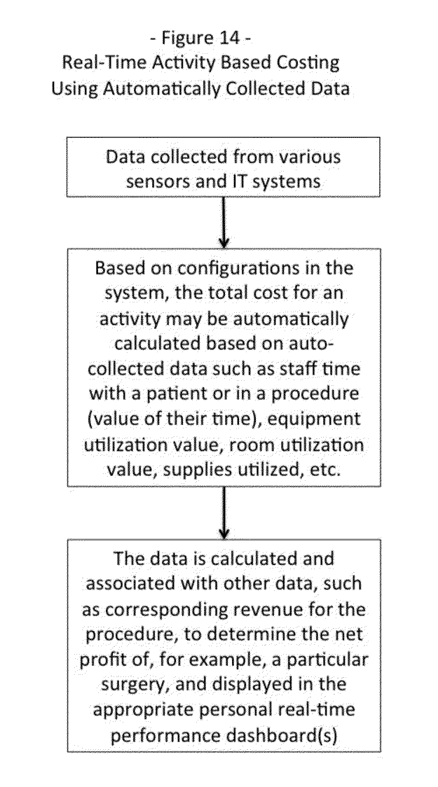

The System continuously collects real-time data that is often relevant in determining a more accurate reflection of the cost of a particular activity, such as a patient surgery. By combining data collected from multiple systems with regards to consumable supplies used, equipment utilized, staff time utilized, physical rooms utilized, and other resources utilized as part of completing a particular activity, in this example a surgery, a very accurate total cost can be ascertained and used in decision support. Refer to FIG. 14 for more information regarding this process.

Once all the data has been collected from the organization's various systems—finance system, electronic medical record system, supply chain system, real-time location system, etc.—the System then calculates the total cost of providing the service or activity based the amount of time each of the resources was utilized. For example, a nurse that is paid $42.00 per hour that spends 150 minutes in a particular surgery would be attributed with $105.00 of cost towards the activity. This would continue for each of the other resources utilized in the activity.

Further, once the total cost was calculated, in real-time or near real-time, it may be coupled with other data, such as revenue generated to then calculate the total profit generated from the activity. Further, this could further be used in analysis to determine the costs/profits by physician, by procedure type, etc. to further aid in making the best decisions possible for the organization.

### Real-Time Performance Management System Architecture

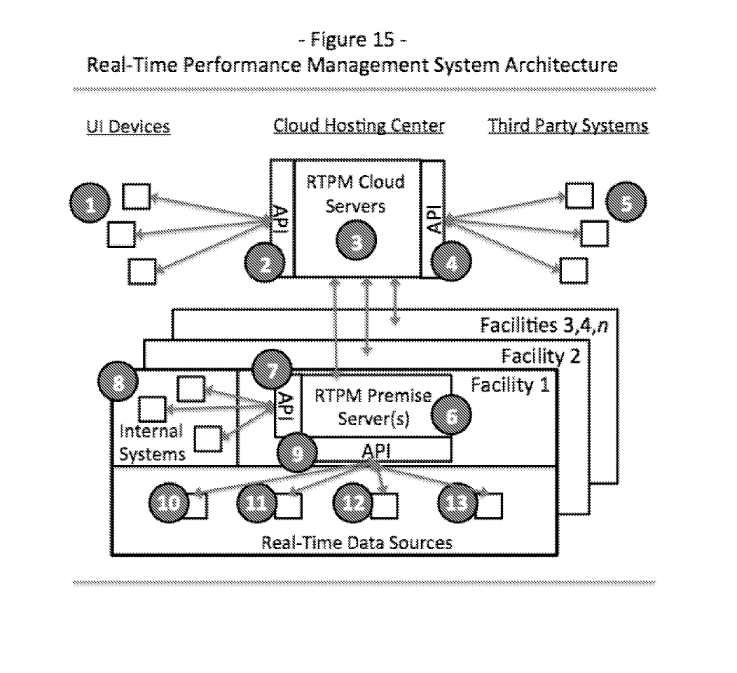

FIG. 15 provides an overview illustration of the Real-Time Performance Management (RTPM) System architecture.

Each organization (or facility, if large) will have host RTPM Premise Server(s) (6) that collect data from a variety of real time data sources at the facility via the Real Time Data Sources API (9), including: Sensors (10), Healthcare IT systems (11), Smart Devices (12), and RTPM applications (13) that all generate real-time data consumed by the RTPM system. Some of the interfaces are one-way and some are two-way, based on the capabilities of the individual data sources.

The RTPM Premise Server aggregates and performs initial processing on the data to normalize it, filter out erroneous or non-value add data, and perform real-time calculations on the data based on the options configured by the system administrator. These calculations are continuously being performed as new data is received so that the data used by other internal and external components have up-to-date metrics available.

The RTPM Premise Server also uses a sophisticated real-time rules engine to compare the calculated metrics against various thresholds and benchmarks configured by the system administrator. The rules may trigger a variety of things to occur, including alerts and notifications. It also provides the data to the RTPM gamification module also located on the RTPM Premise Server, which assesses the metrics and provides updates to the goal attainment, badge award levels, leaderboards, record books, and other performance achievement statistics.

The processed data is then shared via the Internal Systems API (7) to the various Internal Systems (8), such as the organization's Enterprise Data Warehouse, reporting tools, internal website, and other internal systems. The processed information is also sent to the RTPM Cloud Server(s) (3) which may be internally hosted by the organization or externally on a multi-tenant RTPM Cloud Server hosting site.

The RTPM Cloud Hosting Server(s) provides additional processing of the data, and provides customized real-time dashboards to the various UI devices (1) via the UI API (2). The server(s) also provide two-way communication from external Third Party data sources and consuming systems (5) via the Third Party Systems API (4).

### Patient Experience Context Engine

When a patient enters a healthcare facility, there are a myriad of activities and interactions that contribute to the full patient experience. The vast majority of these activities and interactions already are or can potentially be captured automatically as data streams coming from several different types of technology systems. Examples of these systems include, but are not limited to:
Healthcare Information Systems (electronic health records, dietary systems, etc.)
Medical equipment and devices (telemetry data, activity monitors, etc.)
Real-Time Location Systems (patient tracking, staff tracking, asset tracking, etc.)
Specialized applications (real-time feedback, automated check-in, etc.).

The Patient Experience Context Engine (PECE) collects data from these various systems and structures it for analysis and presentation. It also associates this information with a unique patient visit identification ID for each patient so that it may be gathered into a unique record with all details relevant for each and every individual patient visit. From this, the data points may be tied to a single chronological timeline, analyzed for key metrics, assessed against performance standards and goals, and correlated to identify relationships between the various raw and processed data points.

The PECE is a software and data storage system that includes the following components:
Incoming Data Sources API—to collect incoming data from a wide variety of data sources
Outgoing Data API—to allow data to be sent to or accessed by third party systems
System/Device Interfaces—to provide integrations between the APIs and the various incoming and outgoing third party systems
Real-Time Data Processing—to process, organize, analyze, correlate, and store the incoming data in real-time for immediate use as well as historical storage and reporting; this also includes configuration of alerts and notifications based on reaching certain milestones or surpassing thresholds configured via the Administrative Interface
Data Storage—for storage of raw, historical, and real-time data points
Reporting and Analytics—user interface for viewing, analyzing, reporting
Administration Interface—for system administration activities such as user management, security, report definition, system configuration, etc.
Patient Experience Application—for viewing a chronological display of all integrated and available data components with filters to turn the use of various data streams on or off

The PECE provides a unique view and analysis of all aspects of the patient visit that are not otherwise possible by the various systems individually by tying the disparate data point together and using unique and proprietary logic to form meaningful correlations. Specifically, the combination of the various data streams generates new data points and insights via associations and correlative analysis that would not otherwise exist.

The data set from these individual patient visits can then be aggregated and organized for further analysis and reporting, such as for reviewing all visits for a particular patient, all patient visits for designated department, all visits for a particular facility or organization, all patient visits that utilized transport or food services, and so forth. Once the data set is identified and selected, additional calculations and analysis can be performed to generate additional new data points.

This data can even be aggregated across multiple organizations, geographies, patient populations, and so forth for performance of additional analysis and reports.

The value of the PECE processed data is to enable healthcare organizations and payers to use it for improving clinical outcomes, operational efficiency, patient satisfaction, financial improvements, capacity increases, and other performance enhancements.

Following is a partial list of data sources, elements and types utilized by embodiments of PECE:
Patient name and contact data
Patient demographic data
Schedule data
Assigned care team
Clinical data (from the EHR)
Automatically collected data made possible through location and proximity capabilities
   Patient-Provider contact time durations and time stamps
   Wait time timestamps and durations by segments (including projected vs. actual wait times)
   Phase of care timestamps and durations within each department
   Chronological list of all locations traveled within the facility
   List of departments visited with time stamps and locations
   Distance traveled in the facility
   Proximity to staff, equipment, rooms, and other patients while in the facility
   Specific equipment used based on concurrent proximity or direct association
Other medical system data automatically collected
   Bed position
   Nurse call requests time stamps and response times
Feedback submitted during and after the visit/stay—both quantitative (i.e. Net Promoter Score) and qualitative (free form written comments)
Food ordered/delivered
Food Services timestamps (food ordered, delivery time)
Provider rounding (physician and nurses)
Transport requests/arrivals/completions
Lab draw times
Billing/Payer data
Environmental Services—room cleanings—staff name, time stamps
Other clinical and operational data from integrated HIS systems
Other performance data collected and/or generated from automated enterprise visibility systems
Other patient activity and vitals data from fixed telemetry and mobile wearables data automatically collected

In terms of processing of the above data points, the following are a sampling of the ways PECE processes and analyzes the data:
Real-time data analytics processing (rolling time frame windows—totals, averages, minimums, maximums, etc.)
Historical data analytics (totals, averages, minimums, maximums, etc.)
Real-Time Performance Comparison: Actual vs. Goal Comparisons (attain/not attained, variance, % attained, etc.)
Correlated data (i.e. correlation of patient/provider contact time to quantitative feedback scores)

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

What is claimed is:

1. A system for analyzing patient experiences, the system comprising:
at least one interface configured to receive data from a data source relating to a patient visit to a healthcare facility; and
a processing module configured to analyze the received data and associate it with a patient visit identification identifier unique to each patient.

2. The system according to claim 1 further comprising a user interface, wherein the processing module is further configured to present the analyzed data using the user interface.

3. The system according to claim 1, wherein the data source is selected from the group consisting of a healthcare information system, a medical device, and a real-time location system.

4. The system according to claim 1 further comprising a data store, wherein the processing module is further configured to store the associated data in the data store.

5. The system according to claim 1 further comprising a user interface, wherein the processing module is further configured to receive a condition via the user interface.

6. The system according to claim 5, wherein the processing module is further configured to issue a real-time notification via the user interface when the analysis indicates that the received data satisfies the received condition.

7. The system according to claim 1 comprising a plurality of interfaces, wherein the processing module is further configured to identify commonalities in data received from a plurality of sources.

8. The system according to claim 1, wherein the processing module is further configured to compare data associated with different patients.

9. A computer implemented method for analyzing patient experiences, the method comprising:
receiving, using at least one interface, data from a data source relating to a patient visit to a healthcare facility;
analyzing, using a configured processing module, the received data; and
associating, using the configured processing module, the received data with a patient visit identification identifier unique to each patient.

10. The method of claim 9 further comprising presenting the analyzed user data using a user interface.

11. The method of claim 9 wherein receiving data from a data source comprises receiving data from a data source selected from the group consisting of a healthcare information system, a medical device, and a real-time location system.

12. The method of claim 9 further comprising storing the associated data in a data store.

13. The method of claim 9 further comprising receiving a condition via a user interface.

14. The method of claim 13 further comprising issuing a real-time notification via the user interface where the analysis indicates that the received data satisfies the received condition.

15. The method of claim 9 further comprising identifying, using the configured processing module, commonalities in data received from a plurality of sources using a plurality of interfaces.

16. The method of claim 9 further comprising comparing, using the configured processing module, data associated with different patients.

17. A computer readable medium containing computer-executable instructions for performing a method for analyzing patient experiences, the medium comprising:
computer-executable instructions for receiving, using at least one interface, data from a data source relating to a patient visit to a healthcare facility;
computer-executable instructions for analyzing, using a configured processing module, the received data; and
computer-executable instructions for associating, using the configured processing module, the received data with a patient visit identification identifier unique to each patient.
